(19) United States
(12) Patent Application Publication
(10) Pub. No.: US 2009/0273247 A1
(43) Pub. Date: Nov. 5, 2009

(54) DRIVE APPARATUS FOR ELECTRIC VEHICLE

(75) Inventors: Tetsuya Miura, Nishikamo-gun (JP); Wataru Funatsu, Kariya-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 12/304,741

(22) PCT Filed: May 31, 2007
(86) PCT No.: PCT/JP2007/061507

§ 371 Date: Dec. 12, 2008

(30) Foreign Application Priority Data
Jun. 14, 2006 (JP) 2006-164953

(51) Int. Cl. H02K 11/00

(52) U.S. Cl. 310/71

(57) ABSTRACT

A drive device for an electric vehicle, having a structure where a stator is received inside a motor receiving cover to allow an inner cable, connected to the stator, to be led out to the transmission mechanism case side. This enables a projection to be provided on the transmission mechanism case side of the motor receiving cover, and also enables a female connector, connected to the inner cable, to be provided at the projection. The drive device for an electric vehicle has enhanced mountability.

### TECHNICAL FIELD

The present invention relates to a drive apparatus for an electric vehicle, and in particular, to a drive apparatus for an electric vehicle driving an axle by a rotating electric machine.

### BACKGROUND ART

A rotating electric machine having a stator and a rotor is conventionally known. A connecting terminal to which a power cable transmitting electric power from an external power source is connected is attached to the rotating electric machine. For example, in Japanese Patent Laying-Open No. 8-33262, a structure where a terminal is led out from the side of a motor cover is employed.

FIG. 3 shows a structure where a power cable is led out from the upper surface of a rotating electric machine. FIG. 3 is a cross-sectional view taken along the direction of a rotation shaft of a motor 90 that is an example of the rotating electric machine. Motor 90 includes a rotation shaft 94, a rotor 95 fixed around this rotation shaft 94, and a stator 96 arranged to face this rotor 95. Rotation shaft 94 is fixed to a transaxle case (motor/gear case) 92 and a motor cover 91 via bearings. Furthermore, stator 96 is fixed to the inner circumferential surface of cylindrical transaxle case 92. Motor cover 91 is fixed to transaxle case 92 by a bolt B1.

A drive gear 97 is provided on the one end side of rotation shaft 94, and a driven gear 98 engages this drive gear 97 to constitute a transmission mechanism. Drive gear 97 and driven gear 98 are covered with a gear cover 93 fixed to motor/gear case 92 by a bolt B2. Above drive gear 97, an oil catch tank 110 is formed by transaxle case 92 and gear cover 93, and oil 111 is stored in this oil catch tank 110.

In the above configuration, a motor case 90A is formed in a region where rotor 95 and stator 96 are housed, and a transmission mechanism case 90B is formed in a region where the transmission mechanism having drive gear 97 and driven gear 98 is housed. Furthermore, a female connector 85 including a connecting port facing upward is attached to transaxle case 92 on the upper end side of motor cover 91. An internal cable 88 led out from stator 96 is coupled to this female connector 85 by a bolt 87. Internal cable 88 is led out from the opposite side of the transmission mechanism including drive gear 97 and driven gear 98 with stator 96 interposed therebetween. A male connector 84 provided at the tip of an external power cable 83 is inserted into female connector 85 from the upper side toward the lower side.

In a connector structure Al employed in motor 90 having the above-described configuration, internal cable 88 is led out from the opposite side of the transmission mechanism with stator 96 interposed therebetween, and power cable 83 is led out upwardly from motor 90. Therefore, as seen from the direction of the rotation shaft (“A” direction in FIG. 3), the outline of transaxle case 92 is increased in size and vehicle mountability is worsened.

On the other hand, as a connector structure employed in motor 90, there is also a connector structure A2 shown in FIG. 4. In this connector structure A2, female connector 85 including the connecting port facing toward the oil catch tank 110 side is attached, and male connector 84 of power cable 83 is inserted into this female connector 85. In this configuration, although the outline of transaxle case 92 as seen from the direction of the rotation shaft (“A” direction in FIG. 4) is not increased in size, power cable 83 interferes with an outer wall of transaxle case 92 forming oil catch tank 110, which causes a problem with routing of power cable 83.

Both of above-described connector structures A1 and A2 have a configuration where internal cable 88 is led out from the opposite side of the transmission mechanism with stator 96 interposed therebetween. This is because of the shape of transaxle case 92, that is, because an opening region for housing stator 96 is provided on the opposite side of the transmission mechanism with stator 96 interposed therebetween, and internal cable 88 is led out from this opening side.

### DISCLOSURE OF THE INVENTION

Problems to be solved by the present invention are that, in a drive apparatus for an electric vehicle, the outline of the drive apparatus is increased in size and vehicle mountability is worsened because a power cable is led out, and that a problem with routing of the power cable is caused.

The present invention has been made in light of the above problems. An object of the present invention is to provide a drive apparatus for an electric vehicle having improved mountability.

A drive apparatus for an electric vehicle based on the present invention includes a motor case housing a motor, a transmission mechanism case housing a transmission mechanism transmitting motive power of the motor to a drive shaft, and a power cable through which motive power is supplied to the motor.

The power cable is connected to a stator forming the motor on the transmission mechanism case side, and the power cable is fixed radially more inwardly than an outer circumference of the transmission mechanism case and the motor case.

According to the drive apparatus for an electric vehicle based on the present invention, upsizing of the outline of the drive apparatus because the power cable is led out can be avoided without causing a problem with routing of the power cable. As a result, a drive unit for an electric vehicle can be downsized and mountability can be improved.

### BRIEF DESCRIPTION OF THE DRAWINGS

FIG. 1 is a block diagram illustrating a configuration of a motor vehicle including a drive apparatus for an electric vehicle in an embodiment based on the present invention.

FIG. 2 is a cross-sectional view showing a rotating electric machine included in the drive apparatus for an electric vehicle in the embodiment based on the present invention.

FIG. 3 is a cross-sectional view showing a rotating electric machine included in a drive apparatus for an electric vehicle in the background art.

FIG. 4 is a cross-sectional view showing another rotating electric machine included in the drive apparatus for an electric vehicle in the background art.

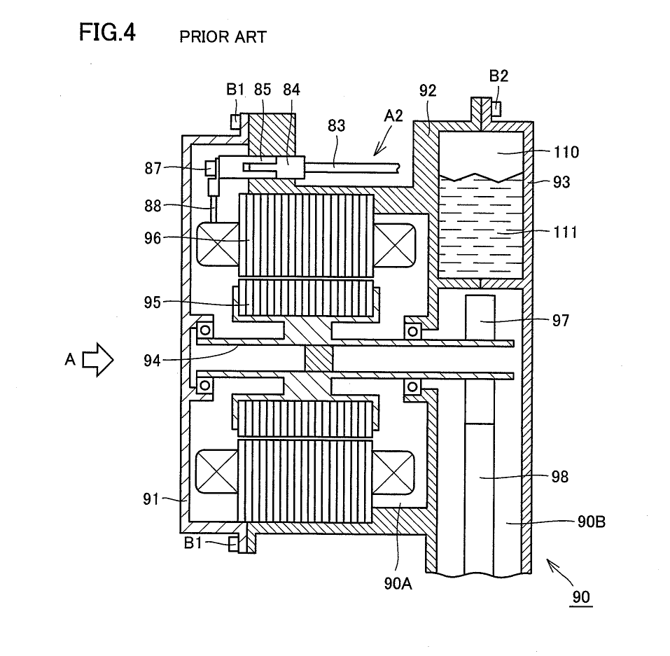

### BEST MODES FOR CARRYING OUT THE INVENTION

A drive apparatus for an electric vehicle in an embodiment based on the present invention will be described hereinafter. It should be noted that the same or corresponding parts as those of the configurations in the above background art are represented by the same reference characters, and the description thereof may not be repeated.

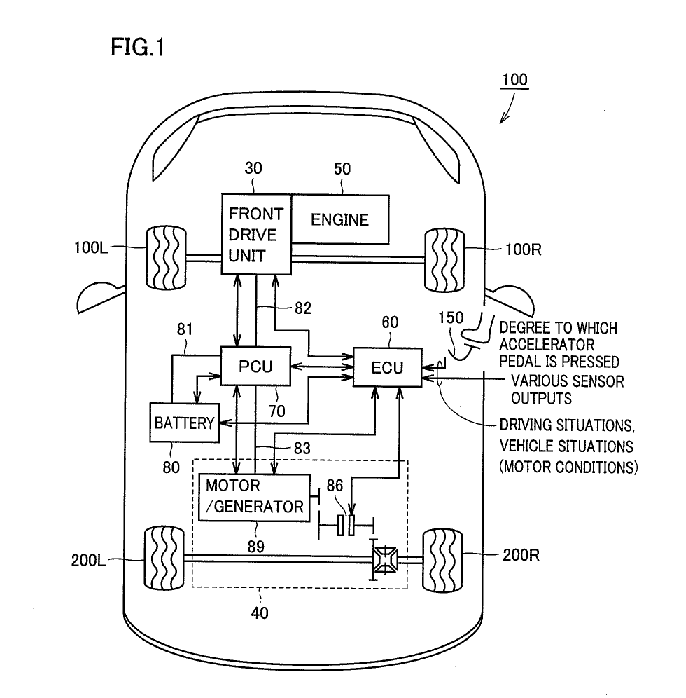

FIG. 1 is a block diagram illustrating a configuration of a motor vehicle including a drive apparatus for an electric vehicle according to one embodiment of the present invention. Referring to FIG. 1, a motor vehicle 100 according to the present embodiment includes front wheels 100L and 100R, rear wheels 200L and 200R, a front drive unit 30 for front-wheel drive, a rear drive unit 40 for rear-wheel drive, an engine 50, an ECU (Electrical Control Unit) 60, a PCU (Power Control Unit) 70, and a battery 80.

Rear drive unit 40 includes a rear motor/generator 89 that is a rotating electric machine used to drive rear wheels 200L and 200R, and a clutch 86. Clutch 86 is provided between rear motor/generator 89 and an axle connected to rear wheels 200L and 200R.

At the time of engagement of clutch 86, torque generated by rear motor/generator 89 is transmitted to the axle, and rear wheels 200L and 200R can be driven. Furthermore, when rear motor/generator 89 is rotated by rear wheels 200L and 200R, for example, during deceleration, rear motor/generator 89 operates as a generator.

Engine 50 is used to drive front wheels 100L and 100R. Front drive unit 30 has a motor for front drive (not shown) built in and drives front wheels 100L and 100R by torque generated by engine 50 and/or the motor for front drive. The motor for front drive can also be operated as a generator when rotated by front wheels 100L and 100R or engine 50.

Information about driving situations and/or vehicle situations from various sensors, including the degree to which an accelerator pedal 150 is pressed and the speed when accelerator pedal 150 is pressed that are detected by a position sensor arranged at accelerator pedal 150, is entered into ECU 60 provided as “control device.” The information about driving situations includes an output from a wheel speed sensor, an output from a vehicle body inclination sensor or the like in addition to an output from the foregoing accelerator position sensor. Furthermore, outputs from a temperature sensor, a current sensor, a rotation speed sensor or the like of rear motor/generator 89, which indicate operating conditions of the motor, are entered as vehicle situations. Based on these entered information, ECU 60 achieves various integrated control over motor vehicle 100.

PCU 70 collectively shows electric power converters required in motor vehicle 100. In other words, PCU 70 includes an inverter (not shown) converting direct current (DC) electric power into alternating current (AC) electric power, a DC-DC converter (not shown) converting the voltage level of a DC voltage, or the like. In particular, this inverter converts DC electric power supplied from battery 80 into AC electric power used to drive the motor, and converts an AC voltage generated when the motor/generator is driven by engine 50 or at the time of regenerative braking operation of the motor/generator itself into a DC voltage used to charge battery 80. The DC-DC converter is mainly used to convert the level of a DC voltage to be appropriate for a power supply voltage for the auxiliaries such as an air conditioner.

Power cables 81, 82 and 83 are disposed between battery 80, front drive unit 30, rear drive unit 40 and PCU 70, respectively, and electric power is transmitted.

In the present embodiment, motor vehicle 100 runs basically by driving front wheels 100L and 100R by front drive unit 30 (an FF mode). When motor vehicle 100 starts moving, when motor vehicle 100 suddenly accelerates and when motor vehicle 100 runs on a path having low coefficient of friction, however, motor vehicle 100 runs by four-wheel driving (a 4WD mode) to achieve stable distribution of driving torque.

In the 4WD mode, a clutch engagement request flag is turned on in ECU 60 and clutch 86 is engaged in response to this flag. As a result, torque output from rear motor/generator 89 is transmitted to the axle of rear wheels 200L and 200R, and rear wheels 200L and 200R are driven in addition to front wheels 100L and 100R. Furthermore, clutch 86 is also engaged at the time of deceleration and braking, so that rear motor/generator 89 is operated as a generator and energy used to charge battery 80 can be recovered.

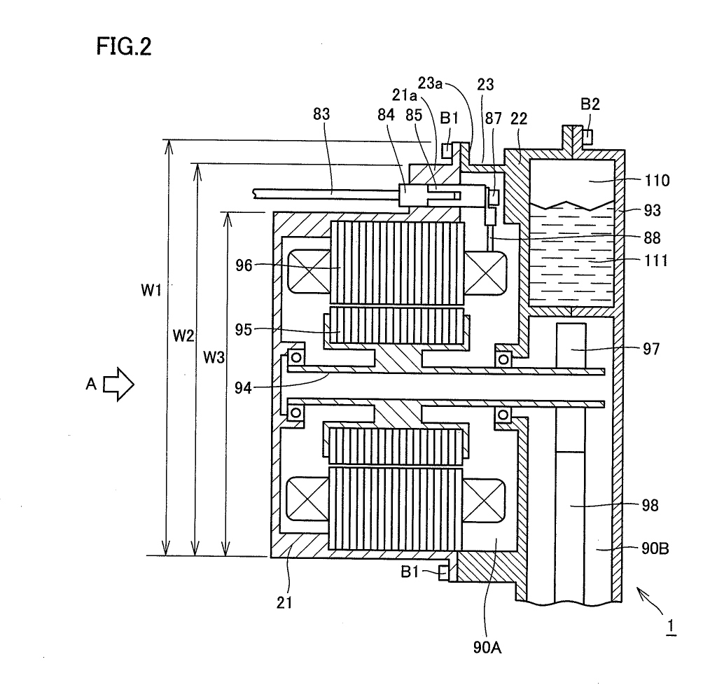

FIG. 2 is a cross-sectional view showing a rotating electric machine 1 included in the drive apparatus for an electric vehicle according to the present embodiment. Rotating electric machine 1 is used, for example, as rear motor/generator 89 in the motor vehicle shown in FIG. 1. In this case, rotating electric machine 1 is connected to PCU 70 via power cable 83 serving as a feeding path connected to a connector (see FIG. 1).

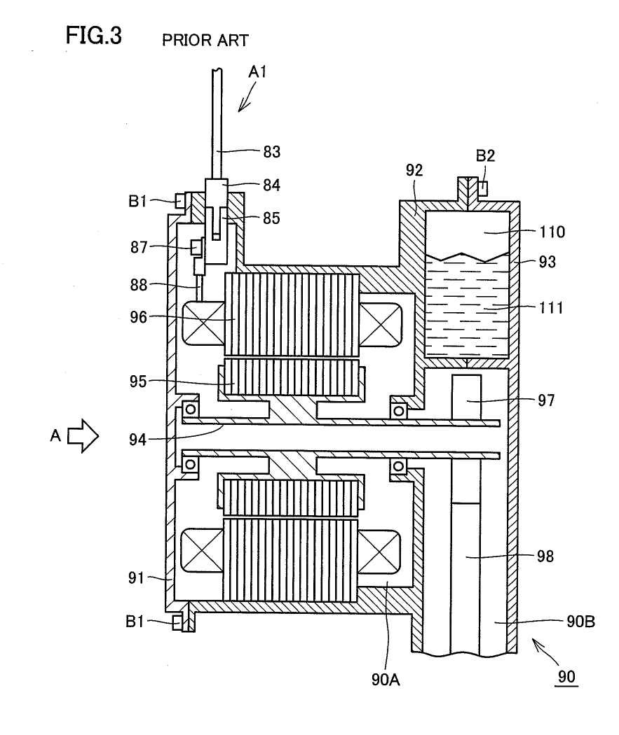

Referring to FIG. 2, a basic configuration of this rotating electric machine 1 is the same as that of motor 90 described in the background art with reference to FIG. 3, and the same or corresponding parts are represented by the same reference characters. This rotating electric machine 1 includes a motor case 90A housing rotor 95 and stator 96 that constitute a motor, a transmission mechanism case 90B housing the transmission mechanism transmitting motive power of the motor to drive shaft 94, and power cable 83 through which motive power is supplied to the motor. This power cable 83 is connected to stator 96 on the transmission mechanism case 90B side, and power cable 83 is fixed radially more inwardly than the outer circumference of transmission mechanism case 90B and motor case 90A.

Specifically, motor case 90A has a motor housing cover 21 holding stator 96 on the inner circumferential surface thereof. This motor housing cover 21 has a bottomed substantially cylindrical shape having an opening on the transmission mechanism case 90B side. Stator 96 is inserted from the transmission mechanism case 90B side. Furthermore, an overhanging portion 21a projecting outwardly from the outer circumferential surface of motor housing cover 21 is provided at this motor housing cover 21 on the transmission mechanism case 90B side.

Consequently, as shown in FIG. 2, a maximum outer dimension W1 of motor housing cover 21 refers to the dimension of the outer circumference of motor case 90A and transmission mechanism case 90B. A dimension W2 between the outer side of overhanging portion 21a and the side of motor housing cover 21 with rotation shaft 94 interposed therebetween is smaller than dimension W1, and an outer dimension W3 of motor housing cover 21 refers to a minimum outer dimension.

As described above, since motor housing cover 21 is cylindrically formed, transaxle case 22 forming a part of motor case 90A in the present embodiment is formed so as to be axially shorter than the transaxle case in the background art. Specifically, a region forming motor case 90A has a sidewall portion 23 and a flange portion 23a projecting outwardly from this sidewall portion 23 and coupled to overhanging portion 21a of motor housing cover 21.

Internal cable 88 coupled to stator 96 is led out to the transmission mechanism case 90B side, and female connector 85 coupled to internal cable 88 by bolt 87 is arranged at and fixed to overhanging portion 21a that is an outer circumferential portion of motor case 90A. The opening side of this female connector 85 faces opposite to transmission mechanism case 90B.

Stator 96 is fixed within motor housing cover 21 and female connector 85 is arranged at overhanging portion 21a in such a manner, so that prescribed parts can be incorporated into motor housing cover 21 in advance and combined into one unit. As a result, the operation of attaching this combined motor housing cover 21 to transaxle case 22 can be simplified and the assembly process of rotating electric machine 1 can be facilitated.

Male connector 84 provided at the tip of external power cable 83 is inserted into female connector 85 from the motor case 90A side toward transmission mechanism case 90B along the direction of the rotation shaft. As a result, power cable 83 is fixed radially more inwardly than the outer circumference of motor case 90A and transmission mechanism case 90B.

As described above, according to the drive apparatus for an electric vehicle in the present embodiment, a configuration where stator 96 is housed within motor housing cover 21 is employed, so that internal cable 88 coupled to stator 96 can be led out to the transmission mechanism case 90B side. As a result, overhanging portion 21a can be provided on the transmission mechanism case 90B side of motor housing cover 21, and female connector 85 coupled to internal cable 88 can be provided at this overhanging portion 21a.

In addition, as seen from the direction of the rotation shaft (“A” direction in FIG. 2), power cable 83 can be fixed radially more inwardly than the outer circumference of motor case 90A and transmission mechanism case 90B, and upsizing of the outline of rotating electric machine 1 because power cable 83 is led out can be avoided. Moreover, as a connector structure, male connector 84 and female connector 85 are arranged so as to be attached and removed along the direction of the rotation shaft, so that compact arrangement of power cable 83 is achieved and a problem with routing of power cable 83 is not caused. As a result, rotating electric machine 1 can be downsized and mountability can be improved.

The embodiments of the present invention have been described above and it should be understood that the embodiments disclosed herein are illustrative and not limitative in any respect. The scope of the present invention is defined by the terms of the claims, and is intended to include any modifications within the scope and meaning equivalent to the terms of the claims.

1. A drive apparatus for an electric vehicle, comprising:
a motor case housing a motor;
a transmission mechanism case housing a transmission mechanism transmitting motive power of said motor to a drive shaft; and
a power cable through which motive power is supplied to said motor,
said power cable being connected to a stator forming said motor on said transmission mechanism case side, and said power cable being fixed radially more inwardly than an outer circumference of said motor case and said transmission mechanism case.

2. The drive apparatus for an electric vehicle according to claim 1, wherein
said power cable is connected by a connector to said stator, and
the connector on said stator side is arranged at said motor case.

3. The drive apparatus for an electric vehicle according to claim 2, wherein
said connector on said stator side is arranged at an outer circumferential portion of said motor case.

4. The drive apparatus for an electric vehicle according to claim 3, wherein
said motor case has a motor housing cover holding said stator on an inner circumferential surface of said motor case,
said motor housing cover has an overhanging portion projecting outwardly from an outer circumferential surface of said motor housing cover on said transmission mechanism case side, and
said connector on said stator side is fixed to said overhanging portion.

5. The drive apparatus for an electric vehicle according to claim 1, wherein
the drive apparatus for an electric vehicle is used as a rear motor/generator within a drive unit for an electric vehicle.

6. The drive apparatus for an electric vehicle according to claim 5, wherein
the electric vehicle includes a front drive unit for front-wheel drive and a rear drive unit for rear-wheel drive, and
the drive apparatus for an electric vehicle is used as a rear motor/generator within the rear drive unit for rear-wheel drive.

7. The drive apparatus for an electric vehicle according to claim 1, wherein
said transmission mechanism case includes an oil catch tank, and
said power cable and said oil catch tank are provided above said drive shaft.

8. The drive apparatus for an electric vehicle according to claim 1, wherein
said power cable is connected by a connector to said stator,
said motor case has a motor housing cover having a bottomed substantially cylindrical shape having an opening on said transmission mechanism case side, and holding said stator on an inner circumferential surface of said motor case such that said stator is inserted from said transmission mechanism case side,
said motor housing cover has an overhanging portion projecting outwardly from an outer circumferential surface of said motor housing cover on said transmission mechanism case side,
said overhanging portion has a female connector coupled to said stator, and
a male connector is provided at a tip of said power cable, and said male connector is inserted into said female connector from said motor case side toward said transmission mechanism case along a direction of said drive shaft.
